(19) United States
(12) Patent Application Publication
(10) Pub. No.: US 2011/0300027 A1
(43) Pub. Date: Dec. 8, 2011

(54) Reactor for generating a product gas by allothermic gasification of carbonaceous raw materials

(75) Inventors: Michael Hofmeister, Rinchnach (DE); Stefan Aniol, Munich (DE); Georg Gallmetzer, Munich (DE)

(73) Assignee: Highterm Research GmbH

(21) Appl. No.: 13/136,594

(22) Filed: Aug. 4, 2011

Related U.S. Application Data
(63) Continuation of application No. PCT/EP2010/058787, filed on Jun. 22, 2010.

(30) Foreign Application Priority Data
Jul. 10, 2009 (DE) DE 102009032524.7

(51) Int. Cl. F27B 15/08; B01J 8/00

(52) U.S. Cl. 422/145; 422/187

(57) ABSTRACT

A product gas is generated from carbonaceous raw materials by allothermic gasification in a reactor. The reactor includes a pressure-charged reformer reactor for gasification of the carbonaceous raw materials, a feed line for feeding carbonaceous raw materials and ancillary materials for gasification into the reformer reactor, a combustion chamber thermally coupled to the reformer reactor for generating the heat required for the allothermic gasification, and a pneumatic conveyor device for removing particulate gasification residue and raw gas from the reformer reactor and for feeding the particulate gasification residue into the combustion chamber. A gas filter separates out the particulate gasification residue from the raw gas. The gas filter has a discharge line for product gas and discharge line for solid particles. A pressure lock has a high-pressure side and a low-pressure side. The gas filter and the pressure lock are separate components. The gas filter discharge line for solid particles is connected to the high-pressure side of the pressure lock.

### CROSS REFERENCE TO RELATED APPLICATION

This application is filed under 35 U.S.C. §111(a) and is based on and hereby claims priority under 35 U.S.C. §120 and §365(c) from International Application No. PCT/EP2010/058787, filed on Jun. 22, 2010, and published as WO 2011/003731 A2 on Jan. 13, 2011, which in turn claims priority from German Application No. 102009032524.7, filed on Jul. 10, 2009, in Germany. This application is a continuation of International Application No. PCT/EP2010/058787, which is a continuation of German Application No. 102009032524.7. International Application No. PCT/EP2010/058787 is pending as of the filing date of this application, and the United States is an elected state in International Application No. PCT/EP2010/058787. This application claims the benefit under 35 U.S.C. §119 from German Application No. 102009032524.7. The disclosure of each of the foregoing documents is incorporated herein by reference.

### TECHNICAL FIELD

The present invention relates to a reactor for generating a product gas through allothermal gasification of carbonaceous raw materials.

### BACKGROUND

The present invention relates in particular to a reactor of the kind in which biogenic raw materials (biomass) such as harvest wastes, wood chips or energy plants, i.e., plants such as Miscanthus that are bred and cultivated specifically for energetic utilization, are reacted as carbonaceous raw materials. The reactor of the invention in particular serves for generating product gas (synthesis gas), a mixture of carbon monoxide and hydrogen having a calorific value of at least 8,000 to 10,000 kJ/m³, i.e., a calorific value that is higher than that of lean gas with approximately 3,500 to 7,000 kJ/m³. By comparison, the calorific value of gas formed from organic substances under the influence of micro-organisms is between 21,000 and 25,000 kJ/m³. The product gas thus obtained may be supplied to a gas engine or a gas turbine for further utilization, to be burnt therein with an efficiency of approximately 35-40%.

The process of allothermal, and thus lastly endothermal, steam reforming of biomass fundamentally takes place in three partial processes: drying, pyrolysis (cracking of long-chained organic compounds substantially in the absence of oxygen when disregarding the oxygen contained in the biomass; excess air coefficient λ=0) and steam reformation, with the product gas forming at the conclusion of the process. All three partial processes unfold simultaneously inside a fluidized bed reactor of a so-called heat-pipe reformer. As a result of the excess air coefficient mentioned above, pyrolysis is delimited from substoichiometric gasification (0<λ<1) involving low oxygen supply and from combustion (λ>1) involving optimum oxygen supply.

During pyrolytic decomposition of biomass under the influence of heat and exclusion of air, gaseous (pyrolysis gas) and liquid (pyrolysis oil) products are formed as well as a coke substantially comprised of carbon, so-called pyrolysis coke. As a general rule, about 80% of the biomass is thereby converted into gaseous products. At temperatures well in excess of 100° C., initially a depolymerization of the polyoses (or hemicelluloses) and celluloses takes place; this is accompanied by a separation of carbon dioxide and reaction water. From about 340° C., aliphatic structures are broken up, and dealkylation results in methane and other hydrocarbons being released. From approximately 400° C., the break up of carbon-oxygen compounds takes place, and a decomposition of the large molecular bituminous compounds formed in the meantime begins. If the temperature is increased even further, other short-chained hydrocarbon compounds are formed. The composition of the products (coke, oil, gas) formed during pyrolytic decomposition is quite substantially dependent on the type and composition of the raw materials, the heating rate, and the temperature level attained (slow pyrolysis vs. fast pyrolysis).

The products of the pyrolysis reactions form the educts of the reforming reactions in which hydrocarbons are separated from the hydrogen in two processes:

CₙHₘ+nH₂O⇄nCO+(n+m/2)H₂

CO+H2O⇄CO₂+H₂ (shift reaction)

The latter process has the purpose of minimizing the proportion of CO and maximizing the proportion of H₂ in the product gas.

At excessively low temperatures (<800° C.) inside the reformer reactor, i.e., that part of the reactor in which the allothermal gasification (pyrolysis) takes place, the degree of reformation of the pyrolysis residue (the pyrolysis coke) is low, which leads to an excess of these residues in the reformer reactor that must subsequently be transferred outside the reformer reactor so as to prevent overflow and choking of the reformer reactor.

For this purpose, a siphon-type construction is known from EP1187892 B1 whereby the residues are discharged directly through a filter layer and via a siphon pipe into a combustion chamber where they are thermally utilized by combustion. The bulk material of the filter layer and its “extension” into the siphon pipe constitutes a pressure seal or pressure-tight lock between the reformer reactor and the combustion chamber. With the aid of a nozzle opening into the siphon pipe, the material contained therein is fluidized and emptied from the siphon pipe into the combustion chamber.

The siphon-type construction disclosed in EP 1187892 B1 has the drawback that concurrent sealing and controlled emptying of the siphon pipe is problematic and frequently results in down times of the installation, which in turn presents a safety risk in the operation of the installation.

Starting out from the device described in EP 1187892 B1, it is therefore an object of the present invention to provide a reactor for generating a product gas through allothermal gasification of carbonaceous raw materials that avoids the drawbacks mentioned in the foregoing.

### SUMMARY

The present invention is characterized in that a gas filter being a functional equivalent of the “filter layer” described in EP 1187892 B1 and a pressure lock whose function in EP 1187892 B1 is equally assumed by the “filter layer” are separate components, and in that a discharge line of the gas filter for solid particles is connected to the high-pressure side of the pressure lock. In addition to the discharge line for solid particles, the gas filter includes a discharge line for product gas. In other words, a separation of product gas and solid particles takes place in the gas filter, and in accordance with the invention, particulate gasification residues in which raw gas is trapped are discharged by means of a pneumatic conveyor device from the pressure-charged reformer reactor and supplied to the combustion chamber via the gas filter and the pressure lock. The separation of gas filter and pressure lock offers the possibility of adapting and optimizing the two independently of each other.

The invention reduces the explosion risk of the product gas that would otherwise be very hot. Moreover, separating the gas filter and pressure lock allows freedom in the design of the gas filter arranged downstream, both in terms of construction and materials, and the service life of the gas filter can be prolonged.

The arrangement of the U-shaped pipe section and of an ascending pipe and thus of the gas filter external to the reformer reactor and external to the combustion chamber, and thus altogether outside of the reactor vessel allows for a compact design and moreover a simple design as the gas filter does not have to be taken into account in terms of construction when configuring the internal space of the reactor vessel. The separate gas filter simplifies the maintenance of the overall installation. The height of the reactor vessel and thus the height difference to be overcome in the upward transport of the particulate gasification residues is such that this transport from the low-pressure side of the gas filter into the combustion chamber now takes place in a gravity-assisted manner. As the first part of the transport trajectory of the pneumatic conveyor device is configured as a downpipe, the transport of the particulate gasification residues also advantageously takes place in a gravity-assisted manner within the reactor of the invention where it would be difficult or even impossible to accommodate a bulky conveyor device.

In addition to the above-described advantage of gravity-assisted transport that gains particular importance in the case of a vertical arrangement, the arrangement or orientation of the first downpipe has the advantage that the first downpipe thus creates the least interference with the device for thermally coupling the reformer reactor to the combustion chamber.

In contrast to the U-shaped pipe section, the ascending pipe is preferably rectilinear so as to reduce frictional resistances. The ascending pipe is configured to be longer than the U-shaped pipe section as it has to overcome the height difference between the end of the U-shaped pipe section and the gas filter. The comparatively long length of the ascending pipe allows a cooling path having substantially the same length and therefore a good cooling effect, while its linearity allows for constructive simplicity of the cooling means. As both advantages are not realized to the same degree in the U-shaped pipe section, arranging the cooling means on the ascending pipe is advantageous.

The use of a steam generator as the cooling means, which may generate electrical energy in combination with a generator, for instance, is advantageous both ecologically and economically. In particular, the electrical energy thus generated may be resupplied to the installation.

As a result of the raw gas line, a fraction of the product gas generated in the reactor reformer during allothermal gasification is supplied directly to the gas filter for removing particulate gasification residues contained therein. Another fraction is conducted to the gas filter in the form of gas trapped in the particulate gasification residues that are discharged from the reactor reformer via the first downpipe. In other words, two lines (the ascending pipe with its upper end and the raw gas line) merge into the gas filter where the particulate gasification residues, having arrived at the gas filter mainly by way of the ascending pipe, and the raw gases, having arrived at the gas filter mainly by way of the raw gas line, are separated out or eliminated. Due to the use of the raw gas line that conducts the raw gas formed during allothermal gasification directly to the gas filter, the raw gas yield and thus the product gas yield are increased. Otherwise without providing for the raw gas line, it would only be possible to transport the raw gas jointly with the particulate gasification residues from the reformer reactor to the gas filter. Consequently, the gas filter would not be capable of removing the entire raw gas carried along in the particulate gasification residues.

Fluid feed lines along the U-shaped pipe section and the ascending pipe ensure that the particulate gasification residues will reliably “slip” through these pipe sections. The transport resistance is influenced and controlled with the aid of parameters, such as the quantity of steam introduced per unit time and the type of steam introduction that may, for example, take place in a pulsating manner to thus have not only a fluidizing effect but also a “vibrating” effect.

The use of steam as a fluid advantageously allows at least partial use or process recycling of gases, such as flue gases, that are formed in the chemical processes unfolding in the reactor vessel of the invention. Moreover, the use of gases and steam has the advantage of preventing the occurrence of an abrupt vaporization that would take place at the prevailing temperatures in the case of water, for example, and would render controlled and uniform transport difficult. Although the steam, which already is in the gaseous state of aggregation during its introduction into the U-shaped pipe section and the ascending pipe, also expands upon contact with the very hot particulate gasification residues, this expansion will nevertheless not be so abrupt, while the formation of bubbles has the effect of loosening up the residues that may be conceived as a “moved fixed bed.” Reducing the transport resistance furthermore makes it easier to overcome the height difference. Controllable, continuous and low-resistance transport thus is accompanied by an economic and safe operation of the overall installation.

The use of a steam lance allows an efficient and space-saving introduction of steam into the pneumatic conveyor device that takes place via branched fluid feed lines, for example at regular intervals or at intervals taking into account the weight force of the combustion chamber bed, i.e., intervals becoming smaller in a downward direction.

The lock is positioned at a lower height than in a case lacking the gas line and in which the ascending line must be routed to at least the same height as the gas filter. The product gas trapped in the particulate gasification residues is in this case extracted through the coarse separator instead of the gas filter, so that the gas filter may be designed to be more simple and particularly more “fine-meshed”, thus resulting in a better quality of the product gas lastly produced.

Heat pipes for thermal coupling between combustion chamber and reformer reactor have the advantage that heat is efficiently and rapidly transported through them from a warmer location (the combustion chamber) to a cooler location (the reformer reactor). The heat transport in terms of quantity of heat and transfer rate may be from 100 to 1000 times that of a geometrically identical component of solid copper material. Heat pipes may further be employed flexibly by adapting, for example, their diameter, the type of their internal lining, their vacuuming, their work medium. Particularly the work medium determines the temperature range in which the heat pipes may be employed. If capillary heat pipes are selected, as opposed to non-capillary heat pipes, even the mounting attitude will hardly have an influence on their efficiency. The advantage of perpendicularly leading out the first downpipe from the reformer reactor has a practical effect. The heat pipes that are customarily and advantageously executed in a rectilinear manner may have a parallel arrangement with the first downpipe such that the combustion chamber and the reformer reactor are thermally coupled by means of the heat pipes preferably being arranged in a common reactor vessel. These features simplify the construction and thus the maintenance of the reactor.

A fluidic comportment of the fluidized bed to which the Archimedean principle may be applied enables both good intermixing for the case of a macroscopically homogeneous bed and likewise vertical demixing for the case of an inhomogeneous bed. Moreover, an excellent heat transport is obtained both inside the fluidized bed and among the fluidized bed and the device for thermal coupling between combustion chamber and reformer reactor such as, e.g., the heat pipes.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a sectional view of a reactor in accordance with a first embodiment of the present invention.

FIG. 2 is a schematic sectional view of a reactor in accordance with a second embodiment of the present invention.

FIG. 3 is a schematic sectional view of a reactor in accordance with a third embodiment of the present invention.

FIG. 4 is a schematic sectional view of a reactor in accordance with a fourth embodiment of the present invention.

FIG. 5 is a schematic sectional view of a reactor in accordance with a fifth embodiment of the present invention.

### DETAILED DESCRIPTION

Reference will now be made in detail to some embodiments of the invention, examples of which are illustrated in the accompanying drawings.

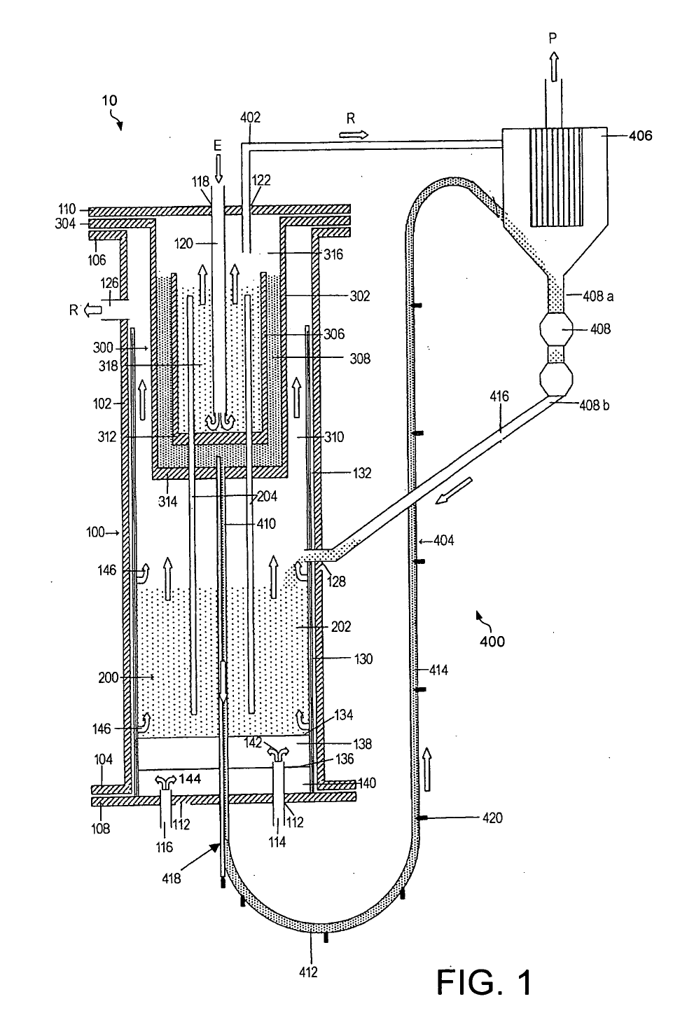

FIG. 1 shows a schematic sectional view of a reactor 10 for generating a product gas P through allothermal gasification of carbonaceous raw materials E in accordance with a first embodiment of the present invention. In accordance with the first embodiment, the reactor 10 of the invention for generating a product gas through allothermal gasification of carbonaceous raw materials includes a reactor vessel 100 in which a combustion chamber 200 and a pressure-charged reformer reactor 300 are arranged. A conduit and filter system 400 is located outside of the reactor 10. These components are described in detail in the following.

The reactor vessel 100 includes a pipe 102 having a circular-annular cross-section, a lower annular flange 104 and an upper annular flange 106. The reactor vessel 100 is sealingly closed at the bottom by a floor 108 and at the top by a lid 110. The floor 108 is connected to the annular flange 104, and the lid 110 is connected via an annular flange 304 to the annular flange 106. The annular flange 304 of the reformer reactor 300 extends in the space between the lid 110 and the annular flange 106. The annular flanges 106, 304 and the lid 110 are releasably and sealingly connected to each other, for example with the aid of bolts or the like that are equidistantly mounted along the periphery of the lid 110. The floor 108 of the reactor vessel 100 has openings 112 through which a primary air flow 142 and a secondary air flow 144 may be introduced via at least one first pipe 114 and at least one second pipe 116.

The lid 110 has an opening 118 through which a feed line 120 passes. The feed line 120 is for feeding carbonaceous raw materials E and ancillary materials into the reformer reactor 300. The lid 110 has a second opening 122 through which a raw gas line 402 passes. The raw gas line 402 is for discharging a part of the raw gas R formed in the reformer reactor 300 out of the reformer reactor 300. The pipe jacket 102 has an outlet opening 126 for discharging from the reactor vessel 100 flue gas R formed in the combustion chamber 200. The pipe jacket 102 also has an inlet opening 128 through which particulate gasification residues are introduced or returned into the combustion chamber 200, as is described in detail below in connection with the conduit and filter system 400.

Concentrically with the pipe 102, an insert 130 that also has a circular-annular cross-section is arranged inside the reactor vessel 100 and extends in an axial direction of the reactor vessel 100 from the floor 108 up to just below the outlet opening 126. The insert 130 has an outer diameter somewhat smaller than the inner diameter of the pipe 102 so that a gap 132 with a circular-annular cross-section is formed between the two. A first partition floor 134 and a second partition floor 136 disposed in parallel with the floor 108 and sealingly connected to the inside of the insert 130 are arranged so as to form a first gas space 138 between the first partition floor 134 and the second partition floor 136. The first pipe 114 opens into the first gas space 138. A second gas space 140 is located between the second partition floor 136 and the floor 108. The second pipe 116 opens into the second gas space 140.

The primary air flow 142, which is conducted into the first gas space 138 through the first pipe 114, passes through holes (not shown) in the first partition floor 134 from below into the combustion chamber 200. The secondary air flow 144, which is conducted into the second gas space 140 through the second pipe 116, passes through holes (not shown) in the peripheral wall of the second gas space 140 formed by the insert 130 into the gap 132 and through additional holes (not shown) in the insert 130. The secondary air flow 144 becomes a secondary air inflow 146 and flows from the sides into the combustion chamber 200 and into the space between the combustion chamber 200 and the reformer reactor 300. The primary and secondary air flows 142 and 144 (in the form of secondary air inflow 146) both serve as a fluidizing agent for the generation of a fluidized bed in the combustion chamber 200 (see below) and as an oxidant for the combustion reactions taking place there. The secondary air flow 144 further serves as thermal insulation of the part of the circular-cylindrical pipe 102 that is located at the level of the combustion chamber 200 and accordingly is exposed to a high temperature. For additional details on the precise arrangement of the lateral holes, see WO 2010/040787 A2 by the same applicant, which is incorporated herein by reference. FIG. 1 shows that the direction of flow of the secondary air inflow 146 flowing laterally into the combustion chamber 200 is changed to an upward direction of flow by the primary air flow 142 flowing into the combustion chamber 200 from below.

The combustion chamber 200 includes a bed 202 that is taken into a fluidized state that corresponds to the operating state of the combustion chamber 200. The bed 202 is taken into the fluidized state through the introduction of primary air flow 142 and secondary air inflow 146 as a fluidizing agent and oxidant. The bed 202 is delimited from underneath by the first partition floor 134 and delimited laterally by a lower portion of the circular-cylindrical insert 130. The bed 202 is substantially made up of sand, possibly with an admixture of a catalyst, and fuels. The primary air flow 142 is introduced through the first pipe 114 into the first gas space 138 and passes into either the bed 202 or the fluidized bed produced by the inflow through a plurality of holes or openings (not shown) that are preferably distributed regularly over the entire surface area of the first partition floor 134 and are dimensioned such that the bed 202 is supported by the first partition floor 134. The bed 202 thus occupies a substantially circular-cylindrical volume and is subjected to a flow of fluidizing agent and oxidant (primary and secondary air flows) through the jacket and the floor.

In accordance with the embodiment of FIG. 1, the reformer reactor 300 is arranged inside the pipe 102 and at a distance above the combustion chamber 200. The reformer reactor 300 includes an outer blind pipe 302 having a circular-annular cross-section at the open side of which the flange 304 is formed as described above. The outer blind pipe 302 forms a pot-shaped reactor vessel. The reformer reactor 300 also includes an inner blind pipe 306 having a circular-annular cross-section. The inner blind pipe 306 is a pot-shaped insert to the outer blind pipe 302. The outer and inner blind pipes 302 and 306 are configured so as to form and define between them a gap space 308 having a U-shaped cross-section. A gap space 310 is formed between the outer blind pipe 306 and the pipe 102.

For all elements of the reactor vessel 100 the have a circular-annular cross-section, the axes of symmetry coincide. FIG. 1 shows that the side wall of the inner blind pipe 306 does not extend as far as the lid 110 and thereby allows the material present in the inner blind pipe 306 to overflow into the gap space 308. A raw gas space 316 is present above the inner blind pipe 306. FIG. 1 shows that the feed line 120 extends down to a short distance from the floor 312 of the inner blind pipe 306.

The combustion chamber 200 and the reformer reactor 300 are coupled by means of heat pipes 204 that are adapted to transport the heat from the bottom to the top of the reactor vessel 100. The heat pipes 204 penetrate the floor 312 of the inner blind pipe 306 and the floor 314 of the outer blind pipe 302. The locations (only two of which are visible in FIG. 1) at which the heat pipes 204 penetrate the plane perpendicular to the axis of symmetry have a regularly distributed arrangement on a circle of this plane. The heat pipes 204 each rectilinearly extend downwards almost as far as the first partition floor 134 and upwards almost as far as the level of the upper edge of the inner blind pipe 306.

The conduit and filter system 400 includes a pneumatic conveyor device 404, a pressure lock 408, a first downpipe 410, a U-shaped pipe section 412, an ascending pipe 414, and a second downpipe 416. The pneumatic conveyor device 404 is connected to a gas filter 406. The pressure lock 408 has a high-pressure side 408a connected to the gas filter 406 and a low-pressure side 408b. The first downpipe 410 extends in a downward direction from the reformer reactor 300 substantially vertically through the reactor vessel 100 from the gap space 308 through the combustion chamber 200, through the first and second partition floors 134, 136 and through the floor 108. The U-shaped pipe section 412 is connected to the lower end of the first downpipe 410. The ascending pipe 414 is connected at one of its ends to an end of the U-shaped pipe section 412 and by its other end to the high-pressure side 408a of the pressure lock 408. The second downpipe 416 is connected by one of its ends to the low-pressure side 408b of the pressure lock 408 and by its other end to the inlet opening 128 of the reactor vessel 100. The first downpipe 410, the U-shaped pipe section 412, and the ascending pipe 414 are integrally connected into an S-shaped pipe that establishes a connection between the gap space 308 and the high-pressure side 408a of the pressure lock 408. The pneumatic conveyor device 404 includes a steam lance 418 and a fluidizing means 420. The steam lance 418 extends along the entire length of the first downpipe 410. The fluidizing means 420 extends along the entire length of the U-shaped pipe section 412 and of the ascending pipes 414. The raw gas line 402 is connected to the gas filter 406.

The curved upper end portion of the ascending pipe 414 is located approximately at the same height as the lid 110 of the reactor vessel 100. The height of a unit consisting of the physically separate elements of gas filter 406 and the pressure lock 408 must be selected to be high enough so that the gradient of the second downpipe 416 is sufficient for conveying the particulate gasification residues solely by gravity.

In the following, the manner of operation of the reactor 10 is described by making reference to FIG. 1. Additional details regarding startup of the reactor 10 are contained in the corresponding descriptions of fluidized bed reactors that are disclosed in other applications to the same applicant.

The primary air flow 142 and the secondary air inflow 146 of the secondary air flow 144 act to transform the bed 202 of the combustion chamber 200 into a fluidized bed comprised substantially of the sand and the fuel. The heat generated during combustion of the fuel with the aid of the oxygen contained in primary and secondary air 142, 144 is transported through the heat pipes 204 into another fluidized bed 318 that is formed in the reformer reactor 300. Fluidized bed 318 is located inside the inner blind pipe 306 of the reformer reactor 300 and is formed by the carbonaceous raw materials E and ancillary materials introduced via the feed pipe 120 into the reformer reactor 300. The heat generated by the combustion serves to gasify the carbonaceous raw materials E in an allothermal manner, as was described above. The particulate gasification residues generated in this process, predominantly coke, spill over the upper edge of the blind pipe 306 into the gap space 308 and from there pass into the first downpipe 410, which is the first section of the S-shaped pipe connecting the reformer reactor 300 to the high-pressure side 408a of the pressure lock 408. The particulate gasification residues are transported through the pneumatic conveyor device 404 to the high-pressure side 408a of the pressure lock 408, which is connected directly to the gas filter 406. The gas filter 406 largely separates the raw gas trapped in the particulate gasification residues from the particulate gasification residues. The gas is output to the outside as a product gas P for further utilization. The particulate gasification residues largely freed from the trapped raw gas are conveyed through the pressure lock 408, the second downpipe 416, and the inlet opening 128 into the reactor vessel 100 to be burnt there. The inlet opening 128 is located above the fluidized bed formed in the combustion chamber 200. The raw gases generated in the allothermal gasification process are further conducted directly, via the raw gas line 402, to the gas filter 406 in which the raw gases freed from the particulate gasification residues floating therein exit from the reactor in the form of product gas P.

In this embodiment, the gas filter 406 acts both as a fine filter for removing floating particles from the raw gas R supplied through the raw gas line 402 and as a coarse filter for separating raw gas R and particulate gasification residues that are supplied via the ascending pipe 404.

### Second Embodiment

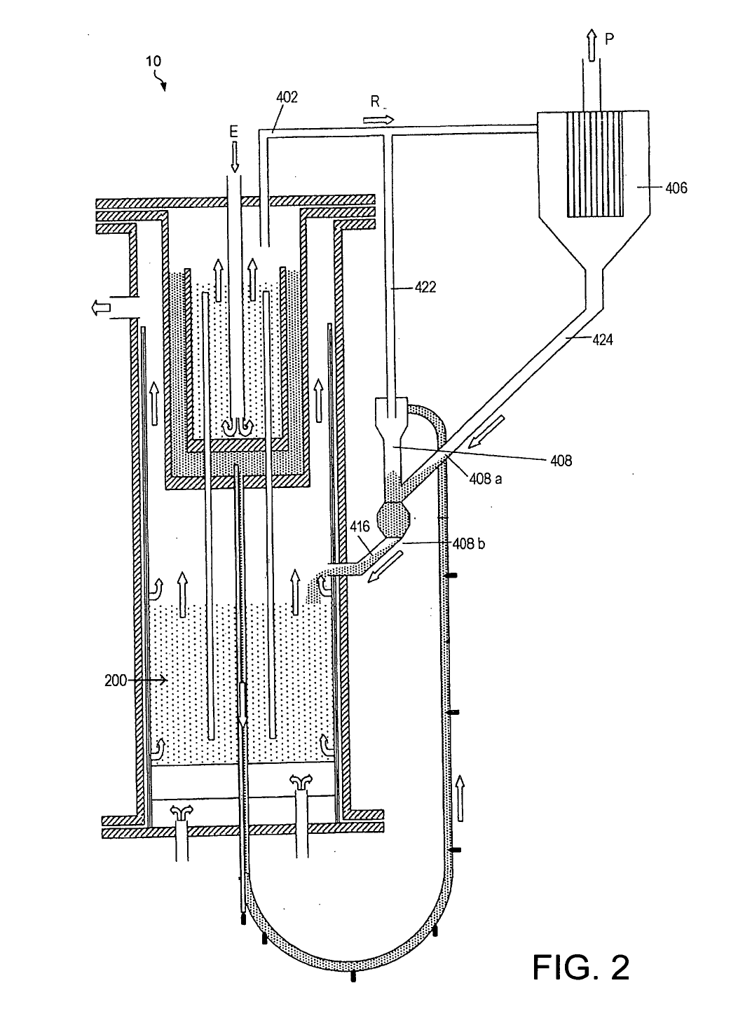

FIG. 2 shows a schematic sectional view of a reactor 10 for generating a product gas P through allothermal gasification of carbonaceous raw materials E in accordance with a second embodiment of the present invention. The reactor 10 in accordance with the second embodiment differs from the one of the first embodiment through a connecting line 422 between the lock 408 and the raw gas line 402, which results in a lower position and a restricted function of the lock 408.

In accordance with the second embodiment, the lock 408 now performs coarse separation, i.e., the separation of particulate gasification residues conveyed in the first downpipe 410, the U-shaped pipe section 412 and the ascending pipe 414 from the raw gas R trapped therein, which is supplied via the connecting line 422 to raw gas line 402 and lastly to the gas filter 406. In turn, the gas filter 406 now only has the function of a fine filter. Not only does the lock 408 have a lower position in comparison with the first embodiment, but at the same time the lock 408 is moved closer to the reactor vessel 100 so that the second downpipe 416 between the low-pressure side 408b of the lock 408 and the reactor vessel 100 is shortened. The distance between the high-pressure side 408a of the lock 408 and the gas filter 406 from a third downpipe 424 that is used to discharge the particulate gasification residues from the raw gas R of the raw gas line 402 and from the connecting line 422 now has a greater length.

### Third Embodiment

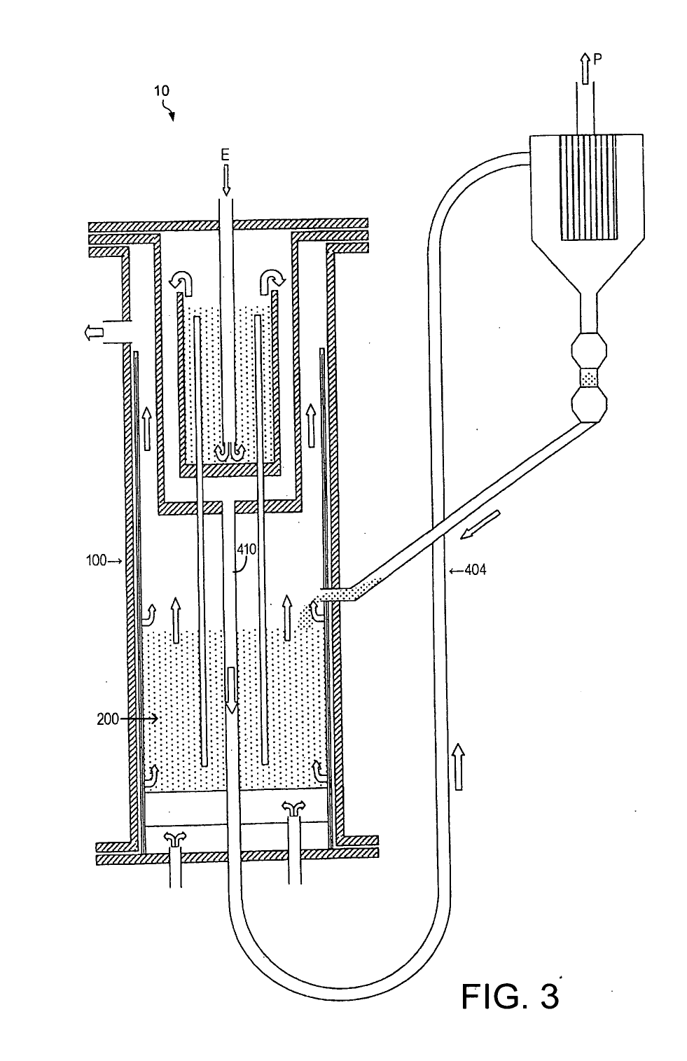

FIG. 3 shows a schematic sectional view of a reactor 10 for generating a product gas P through allothermal gasification of carbonaceous raw materials E in accordance with a third embodiment of the present invention. The reactor 10 according to the third embodiment differs from the one of the first embodiment only by the omission of the raw gas line 402. The entire raw gas R generated in the gasification process is discharged, together with the particulate gasification residues, via the first downpipe 410 from the reactor vessel 100 and supplied to the combustion chamber 200 on the path described in connection with the first embodiment.

### Fourth Embodiment

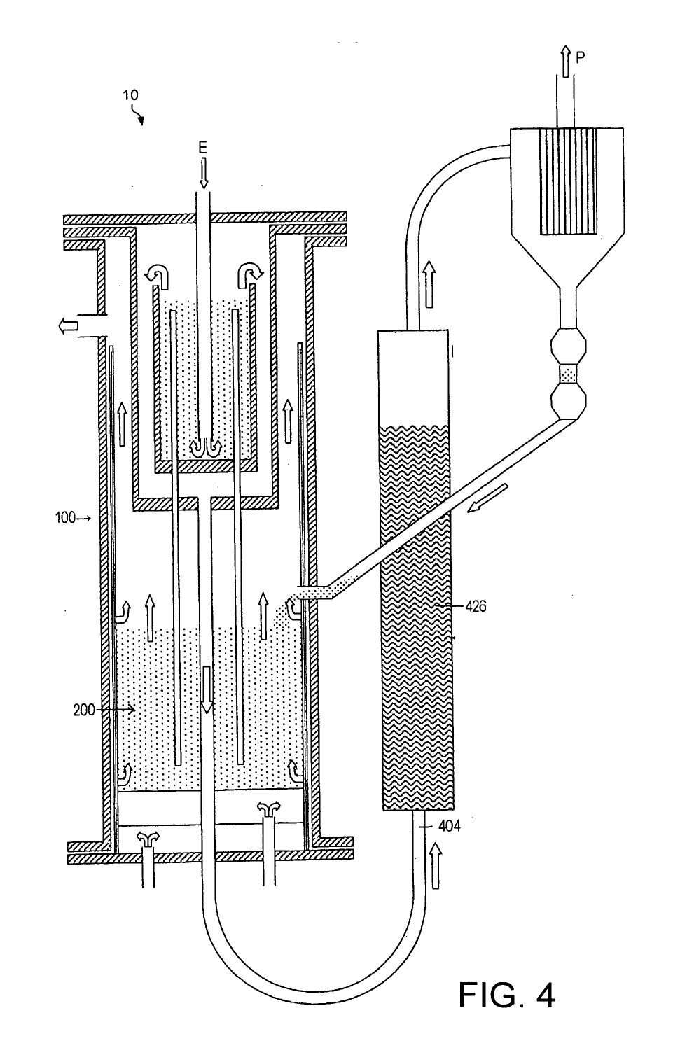

FIG. 4 shows a schematic sectional view of a reactor 10 for generating a product gas P through allothermal gasification of carbonaceous raw materials E in accordance with a fourth embodiment of the present invention. The reactor 10 according to the fourth embodiment differs from the one of the third embodiment only in that the ascending pipe 404 is enclosed by a cooling means 426. In one aspect, the cooling means 426 is configured as a steam generator.

### Fifth Embodiment

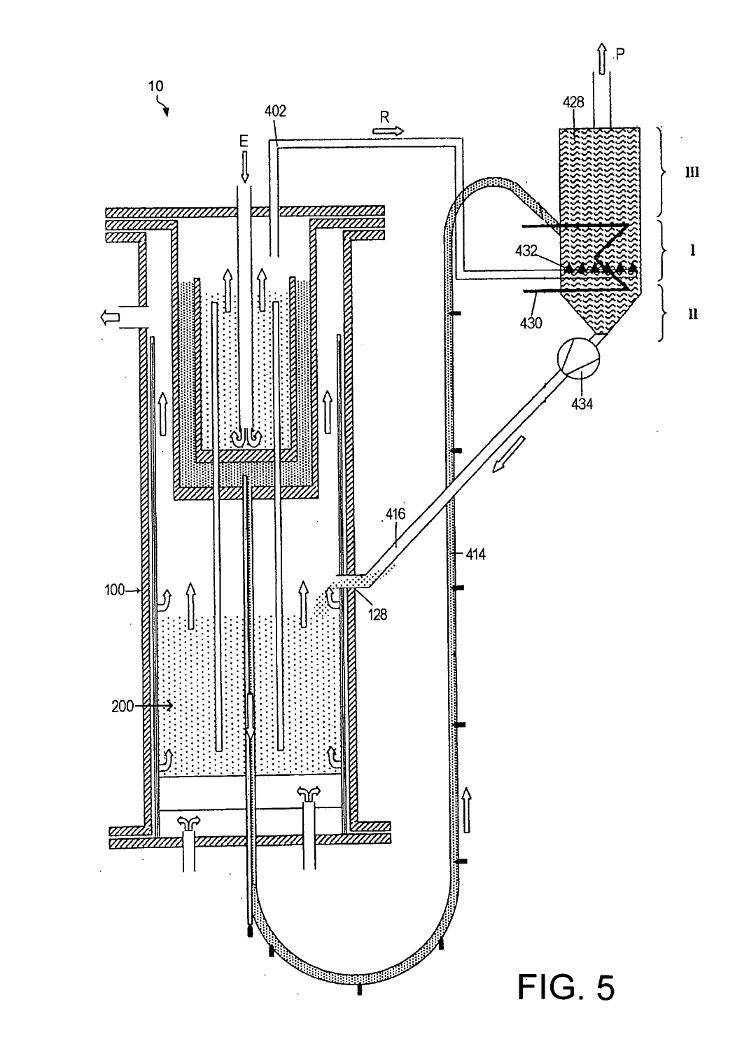

FIG. 5 shows a schematic sectional view of a reactor 10 for generating a product gas P through allothermal gasification of carbonaceous raw materials E in accordance with a fifth embodiment of the present invention. The reactor 10 in accordance with the fifth embodiment constructively differs from the one of the first embodiment in that the subassembly of the first embodiment including the gas filter 406 and the pressure lock 408 is replaced with a subassembly including a gas scrubber 428. The gas scrubber 428 includes a cooling loop 430 for cooling the raw gas R, a dust washer 432 and a pump 434. The gas scrubber 428 is subdivided into three zones I, II and III. The raw gas line 402 and the ascending pipe 414 open into zone I. In zone I, the raw gas R is cooled and dust washing takes place. Zone II is adjacent to zone I and is connected to the pump 434. A slurry is collected in zone II. The slurry contains tar condensate, water, dust and a solvent such as Rape Methyl Ester (RME). RME is a biodiesel fuel obtained by transesterification of rapeseed (canola) oil with methanol. The slurry is pumped out of zone II by pump 434. The product gas outlet-side of gas scrubber 428 is third zone III. Water and tars condense in zone III. The pump 434 pumps the slurry via the second downpipe 416 through the inlet opening 128 and into the reactor vessel 100.

### Reference Symbols

10 reactor

100 reactor vessel

102 circular-cylindrical pipe

104 lower annular flange of 102

106 upper annular flange of 102

108 floor of 102

110 lid of 102

112 openings

114 first pipe

116 second pipe

118 opening in 110 for 120

120 feed line for E

122 opening in 110 for 402

126 outlet opening for R in 102

128 inlet opening in 102

130 insert in 102

132 circular-cylindrical gap

134 first partition floor

136 second partition floor

138 first gas space

140 second gas space

142 primary air flow

144 secondary air flow

146 secondary air inflow

200 combustion chamber

202 bed

204 heat pipes

300 reformer reactor

302 outer blind pipe

304 annular flange at 302

306 inner blind pipe

308 U-shaped gap space

310 gap space between 102 and 302

312 floor of 306

314 floor of 302

316 raw gas space

318 fluidized bed in 306

400 conduit and filter system

402 raw gas line

404 pneumatic conveyor device

406 gas filter

408 pressure lock

408a high-pressure side of 408

408b low-pressure side of 408

410 first downpipe

412 U-shaped pipe section

414 ascending pipe

416 second downpipe

418 steam lance

420 fluidizing means

422 connecting line

424 third downpipe

426 cooling means

428 gas scrubber

430 cooling loop

432 dust washer

434 pump

E raw materials

P product gas

R raw gas

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-18. (canceled)

19. A reactor for generating a product gas through allothermal gasification of carbonaceous raw materials, comprising:
a reformer reactor that gasifies the carbonaceous raw materials, wherein the reformer reactor is pressure charged;
a combustion chamber that is thermally coupled to the reformer reactor, wherein heat is generated inside the combustion chamber that is required for the allothermal gasification;
a pneumatic conveyor device that discharges particulate gasification residues and raw gas from the reformer reactor;
a gas filter that separates out the particulate gasification residues from the raw gas, wherein the gas filter includes a first discharge line for product gas and a second discharge line for solid particles; and
a pressure lock having a high-pressure side and a low-pressure side, wherein the second discharge line for solid particles is connected to the high-pressure side of the pressure lock.

20. The reactor of claim 19, wherein the pneumatic conveyor device includes a first downpipe, a U-shaped pipe and an ascending pipe, wherein the U-shaped pipe and the ascending pipe are located outside of the reformer reactor and outside of the combustion chamber, wherein the first downpipe removes the particulate gasification residues from the reformer reactor, wherein the U-shaped pipe connects the first downpipe to the ascending pipe, and wherein the ascending pipe has an upper end that is connected to the gas filter and the high-pressure side of the pressure lock.

21. The reactor of claim 19, wherein the gas filter and the pressure lock are located outside of the reformer reactor and outside of the combustion chamber.

22. The reactor of claim 20, further comprising:
a second downpipe connected to the low-pressure side of the pressure lock, wherein the second downpipe feeds the particulate gasification residues into the combustion chamber.

23. The reactor of claim 20, wherein the first downpipe extends substantially vertically from the reactor reformer.

24. The reactor of claim 20, further comprising:
a cooling means disposed around the ascending pipe.

25. The reactor of claim 24, wherein the cooling means is a steam generator.

26. The reactor of claim 19, further comprising:
a raw gas line that feeds the raw gas generated in the reformer reactor to the gas filter.

27. The reactor of claim 20, further comprising:
fluid feed lines disposed along the U-shaped pipe and the ascending pipe, wherein the fluid feed lines assist the pneumatic conveyor device to transport particulate gasification residues.

28. The reactor of claim 27, wherein the fluid feed lines feed steam into the pneumatic conveyor device.

29. The reactor of claim 20, further comprising:
a fluid lance that extends from outside the combustion chamber and reformer reactor into the reformer reactor, and wherein the fluid lance loosens the particulate gasification residues in the reformer reactor.

30. The reactor of claim 29, wherein the fluid lance is a steam lance.

31. The reactor of claim 29, wherein the fluid feed lines branch out from the fluid lance into the first downpipe.

32. The reactor of claim 26, wherein the pressure lock includes a coarse separator that separates solids, and wherein the coarse separator is connected by a gas line to the raw gas line.

33. The reactor of claim 19, further comprising:
heat pipes that thermally couple the combustion chamber to the reformer reactor.

34. The reactor of claim 20, wherein combustion chamber and the reformer reactor are disposed in a common reactor vessel, and wherein the first downpipe penetrates the combustion chamber and the common reactor vessel.

35. The reactor of claim 34, wherein the reformer reactor is disposed above the combustion chamber in the common reactor vessel.

36. The reactor of claim 34, wherein the common reactor vessel and the reformer reactor are closed by a common lid.

37. The reactor of claim 36, wherein the reformer reactor includes a pot-shaped reactor vessel with a pot-shaped insert, wherein the pot-shaped insert is held at a distance from the inner sides of the pot-shaped reactor vessel, wherein the pot-shaped insert is open at the top, wherein the allothermal gasification takes place in the pot-shaped insert, and wherein the first downpipe opens into the pot-shaped reactor vessel below the pot-shaped insert.

38. The reactor of claim 19, wherein a fluidized bed is formed inside the combustion chamber.

39. The reactor of claim 19, wherein a fluidized bed is formed inside the reformer reactor.
